(19) United States
(12) Patent Application Publication
(10) Pub. No.: US 2014/0367112 A1
(43) Pub. Date: Dec. 18, 2014

(54) DEVICE FOR RECIRCULATING GREASE/SEALING OIL IN RISERS

(71) Applicant: Green Well Technology AS, Østre Gausdal (NO)

(72) Inventor: Kjetil Sevaldsen, Ostre Gausdal (NO)

(73) Assignee: Green Well Technology AS, Østre Gausdal (NO)

(21) Appl. No.: 14/353,229

(22) PCT Filed: Oct. 22, 2012
(86) PCT No.: PCT/NO2012/050205

§ 371 Date: Apr. 21, 2014

(30) Foreign Application Priority Data
Oct. 21, 2011 (NO) 20111428

(51) Int. Cl. E21B 33/072; B03C 1/32; E21B 33/076; E21B 41/00; F16N 33/00; F16N 7/38; F16J 15/40; B03D 1/00

(52) U.S. Cl. CPC E21B 33/072; F16J 15/406; B03C 1/32; B03D 1/00; E21B 41/0007; F16N 33/00; F16N 7/38; E21B 33/076
USPC 166/335; 277/432; 184/6.25; 277/304

(57) ABSTRACT

A device for collecting used sealing fluids/grease being used as sealing and lubricating medium between two objects such as risers.

### BACKGROUND

Within the oil industry, and then inter alia for use when lowering/taking up equipment and similar in risers when there shall be conducted different service operations with cable in an oil well, it is necessary to use sealing fluids functioning as barriers towards the surroundings, inter alia for preventing unwanted blow-out situations. In such instances it is customary to use sealing fluids (“grease”).

Sealing fluids consequently serve an important function by resisting pressures that originate from well holes, and that may be very high. Under such conditions it may also be used lubricating oil for lubricating the components of such equipment. The function of the grease may also be a lubricating one.

Cable operations are also the object for some og the most corrosive environments being known in an oilfield, and consequently it is important with a god lubricating capability and corrosion inhibition. Typical sealing fluids may thus contain or may be added inhibitors reducing the corrosive effects from sea water, acids, corrosive substances as well as gases such as CO₂ ad H₂S. Optionally also emulsifiers may be added for preventing the formation of an emulsion.

Good sealing fluids consequently make it easier to isolate and maintain the well pressure around moving movable and stationary service cables, and provide an important contribution for prolonging the life expectancy and service time for well service cables in the hydrocarbon field.

The sealing fluid fills up the annular space between the riser pipe and the service cable as well as the equipment being lowered with this, and forms a fluid sealing containing well fluids. Naturally there will simultaneously exist an up and downward motion, in relation to the riser, of all equipment, tools etc. that accompany the service cable. The combination of lowered equipment, service cable and sea fluid provides a pressure barrier against well gases and fluids.

Eventually there will arise wear effects by e.g. metal grinding against metal, and grinding away and/or removing material as a consequence of these movements, and thereby polluting the sealing fluid. If nothing is done with the sealing fluid in the form of purification or replacement, this may become so polluted with e.g. metal fragments and drilling grit that is will eventually become difficult and even impossible to maintain a safe pressure barrier for retaining the well fluids. Abundant wear may thus provoke a reduced efficacy in the oil and gas production. Additionally with an ever increasing wear there will arise a. corresponding need for more sealing fluid resulting in even bigger working costs.

Normally it has thus been customary to use sealing fluids only once in the system before it passes to collection after having been transported ashore in separate containers.

However, from cost and environmental considerations there has eventually arisen a requirement for recirculation and re-use while there not being any interruptions in the production per se. Thus there will be a strongly reduced consumption of sealing fluids and a reduced need for transportation ashore, in its turn providing cost reductions.

### PRIOR ART

The existing conventional way to handle the above indicated problem complex is to supply sealing fluid to the well operations through a conventional oil barrel being connected to a sealing fluid pumping unit in its turn being connected to the technical equipment forming the oil and gas well. Spillage of return fluid being returned from the oil well is conducted into oil barrels. On account of impurities in the spillage, compared to new sealing fluid, the spillage may not be used again in the well drilling operations. Barrels with spillage will consequently have to be transported (from offshore to onshore, or form onshore to another location) for destruction in a suitable destruction facility. There exist special films specializing in handling the destruction of sealing fluids having gone to waste.

Conventionally sealing fluids are supplied from conventional oil barrels to the sealing fluid pumping unit, and spillage of this fluid is transferred to empty conventional oil barrels.

The technological solution of today is characterized by a small degree of innovation and consists, as indicated, of using conventional oil barrels and barrels for spillage (empty oil barrels to be filled with spillage) and manual removal of the spillage when the spillage barrel is empty.

Obviously there does not exist any good technological solution to the indicated problem, and there probably does not exist any known technique for handling sealing fluid beyond the indicated conventional process.

The conventional solution of today for supplying sealing fluids in well operations and handling sealing fluid spillage, additionally creates unfortunate health, environmental and safety hazards.

By using the present invention it is possible to recirculate sealing fluid spillage thhas not been used for barrier purposes. The invention may take care of all HES factors in a remarkable way.

By recirculating sealing fluid directly on the workplace it is possible to reduce the number of liters of used sealing fluid by 80%. Considering the estimated use on the Norwegian shelf in the North Sea this will constitute a reduction in the number of liters used sealing fluid from 220.000 liters to 44.000 liters.

Additionally it is also possible, by reducing the amount of used sealing fluids, to reduce the manual lifting operations being necessary to handle sealing fluid barrels, providing a substantial health and. safety benefit.

In addition to the environmental benefit resulting from a reduced used of sealing fluids and a reduced need for destructing used sealing fluid spillage, the involved logistics operations connected to the transport of sealing fluids and sealing fluid spillage, is reduced with 80%, and this will by itself also provide a substantial environmental benefit.

It should, however, be mentioned that there has been a technological development connected to the equipment and the components being used in the well proper, these either being indicated as flow tubes, sluices, valve trees or wire. These are, however, technical devices being meant to function within the well per se, and do not replace sealing fluid as a barrier, but requires the use thereof. Thus it is known technology associated. with functions and operations within the well per se, but these do not touch directly the supply of new sealing fluid and/or the handling of sealing fluid spillage.

The present invention is consequently a device that is to remedy defects and disadvantages with the prior art, since it provides a processing device for cleaning, handling and recirculating sealing oil and grease.

### DESCRIPTION OF FIGURES

The following disclosure will be more easily comprehended with support and reference to the enclosed figures, wherein:

FIG. 1 shows how an embodiment of a device according to the invention is coupled up to an existing well.

FIG. 2 shows an embodiment of a first separation unit.

FIG. 3 shows an embodiment of a third separation unit.

FIGS. 4-12 show embodiments of details of first and second separation units.

FIG. 13 shows an embodiment of connection structures of pipelines of an embodiment of a combined separation unit according to the invention.

### SUMMARY OF THE INVENTION

Condensed the invention concerns a device and process as defined in the enclosed set of claims.

### DETAILED DISCLOSURE OF THE INVENTION

The invention, indicated by the abbreviation GRS—Grease Recycling System—aims to store sealing fluid/grease to be used in well operations, and recirculating waste sealing fluid/grease continuously as the grease returns from the well operation. FIG. 1 shows an embodiment of how a device according to the invention is connected to an existing oil well.

A GRS-device (I) comprising a grease tank (III), a grease pump unit (VII) pumping grease to an oil well riser including a well head with a valve tree (IV), a sluice (V) for in-well equipment and pressure control device (VI) with flow tubes connected to the oil well, is deployed together with the rest of the wire line equipment in a container. When assembling equipment in the work area, the container (III) is placed to the side of an sealing fluid/grease tank unit (VII). The tank unit (VII) is filled with the sealing fluid/grease from the recycle unit (III) and a grease return pipeline (VIII) as well as a line wiper return pipeline (IX) are connected directly to the GRS device (I) at an inlet and an outlet of the GRS-device (I), respectively. There is connected a fresh air flushing with a return to a safe region for airing and possible H₂S-suppy via return (not shown).

In an embodiment the recirculation unit (I) includes originally 1050 liters of sealing fluid/grease on arrival. By filling up the tank of the sealing fluid/grease unit (VII) the amount will decrease (depending on the type of sealing fluid unit) by 2-300 liters. It will be obtained about 80% of sealing fluid in return, provided a correct selection of connecting pipes against the relevant cable. On account of the purification system in recirculation unit (I) all the returned sealing fluid/grease passes to re-use. This means that in practice there has been used 2950 liters of sealing fluid when the level in the recirculation unit (I) has sunk by 600 liters.

Then 3 new barrel of sealing fluid/grease is to be introduced to be recirculated into the remaining 400 liters in a floatation tank (III) in the grease recycling system (I) (a second separation unit in the GRS system, disclosed infra). When using e.g. “Clare W 500” (green sealing fluid) the recirculation has to be assembled oppositely from when the classic “Polybutane Multigrade” is used since they possess the same properties, but opposite in the separating phase.

In the embodiment disclosed supra, the unit is not to be lifted out of the container when in use. By opening the container door there is obtained access to all the necessary functions (see FIG. 13). It has been considered that the daily maintenance is to be as simple as possible, and that all the components that are to be served are accessible from a top box in the front lid. All the necessary connections are present in a separate storage compartment in the top box on the left hand side. All handling of used or dirty/polluted. spill grease barrels is not required and the barrels that are to be added for replacing the spill/grease reduction remains the same.

By using sealing fluid as a barrier towards the atmosphere it is possible to perform frequent well operations within the oil and gas industry. It is a requirement and a necessity that service is performed regularly for maintaining the production as well as surveying the safety by changing safety valves and the like.

In FIG. 1 it is displayed an oil well with a mounted pressure control unit ready for a service task. Instead of introducing a 200 1 barrel of sealing fluid there is introduced a GRS being full of new sealing fluid. The sealing fluid pump unit VII is filled from the GRS and the operation ay commence. When the sealing fluid pump VII is almost empty of sealing fluid, it must be refilled from the GRS and each filling operation requires 350 liters. When it continuously is returned 80% of sealing fluid to the GRS, and the GRS originally was filled with 1000 liters of sealing fluid, there is in practice available almost 3000 liters of sealing fluid here, without it being necessary to transport a single barrel.

A normal consumption of sealing fluid is one barrel per 24 hours per job, but the consumption increases in high pressure wells.

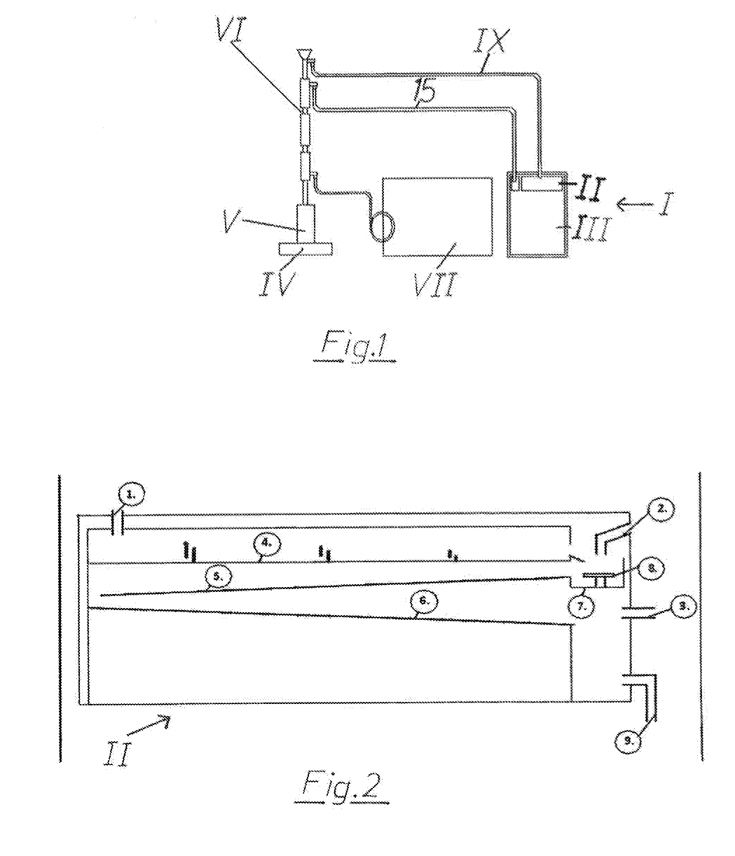

The top box (first separation unit II) is indicated in FIG. 2 with reference numbers 1-9:

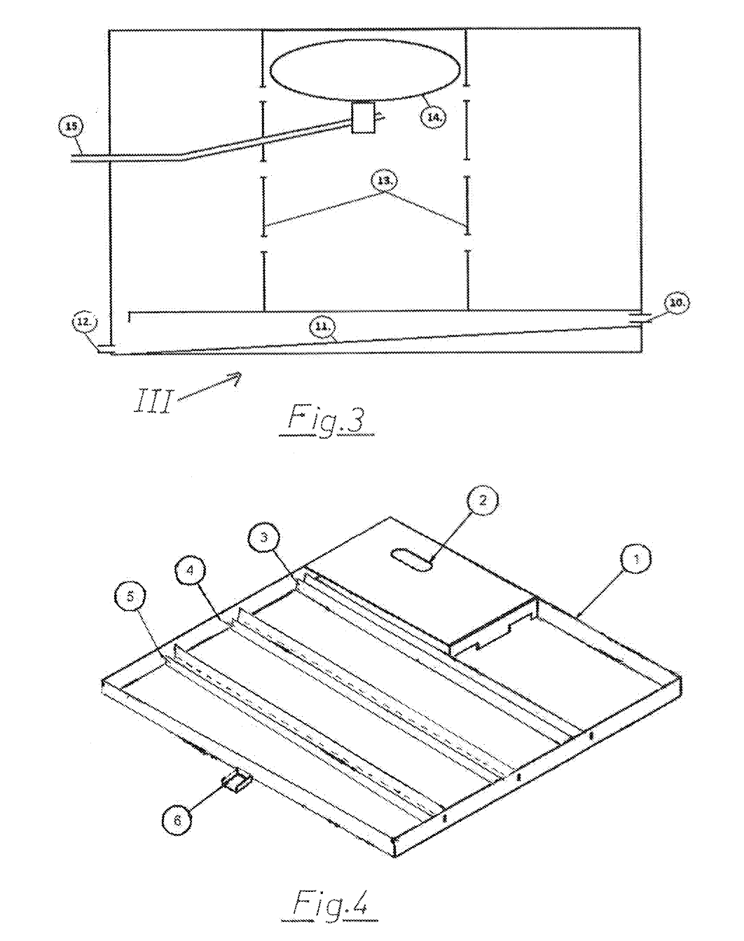

Line Wiper blows the remaining sealing fluid out from the pipe/cable IX with pressurized air when the cable is removed from the well so that sealing fluid entering via (1) is foamed with air bubbles that have to be separated in the “Line Wiper Board” (4). The foam remains behind the three baffles in the depicted embodiment, before the sealing fluid flown down onto the magnet (8) in the distribution chamber (7). The return of sealing fluid from the pressure control flow pipe enters via entrance conduit (2) and flows directly down onto the magnet (8) in the distribution chamber (7). The function of the distribution chamber is to collect sealing fluid so that it flows out in full breadth over at least one separation table (5,6) so that possible bubbles of H₂S migrate out. The separation tables (5,6) have punched or cut grooves or tracks for catching possible fragments of drilling grit etc. when sealing fluid flows past, before the sealing fluid is collected and flows through an exit (9) down to an inlet (10, see FIG. 3)) leading sealing fluid to the bottom of the tank through a flotation device.

In the top box (II) there is an entrance (3) for fresh air/pressurized air for removing migrated H₂S to a safe region through an air return aperture.

When sealing fluid enters into the flotation tank (unit III) of the device according to the invention through the conduit (10) (see FIG. 3), the sealing fluid is forced to move across the tank to the opposite side of the tank (III) so that well liquid, diesel, drainage, water, etc. has time to sink to the bottom at a drainage exit (12). Other liquid components than sealing fluid/grease will then descend below a separation floor (11) and may be drained through the drainage exit (12) at the bottom of the tank (III).

When the drainage fluid has entered into the flotation tank (III), the sealing fluid/grease will migrate up a narrow passage above the drainage exit (12) and ascend in the tank (III) inside circulation walls (13). Sealing fluid/grease is pumped to be re-used through exit (15) being secured to a floater/floatation device (14).

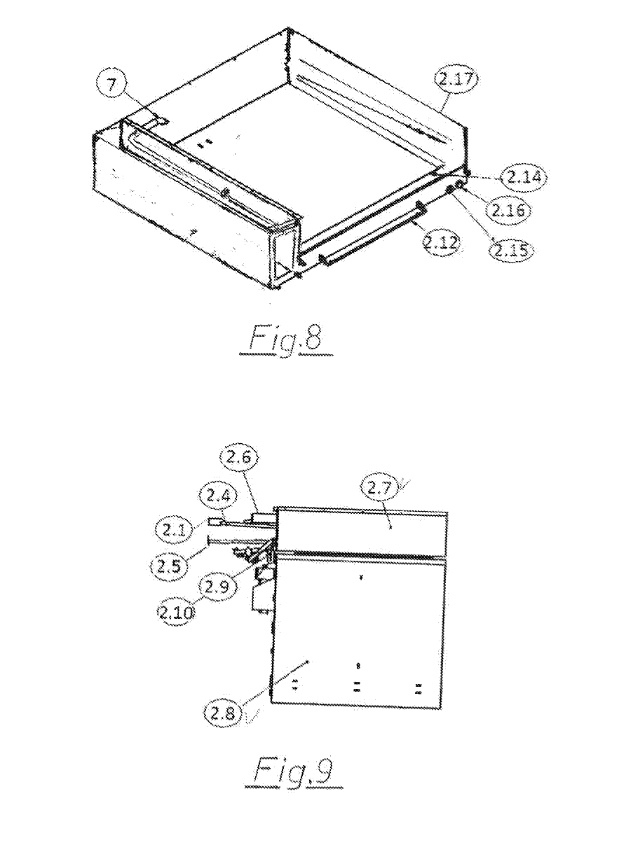

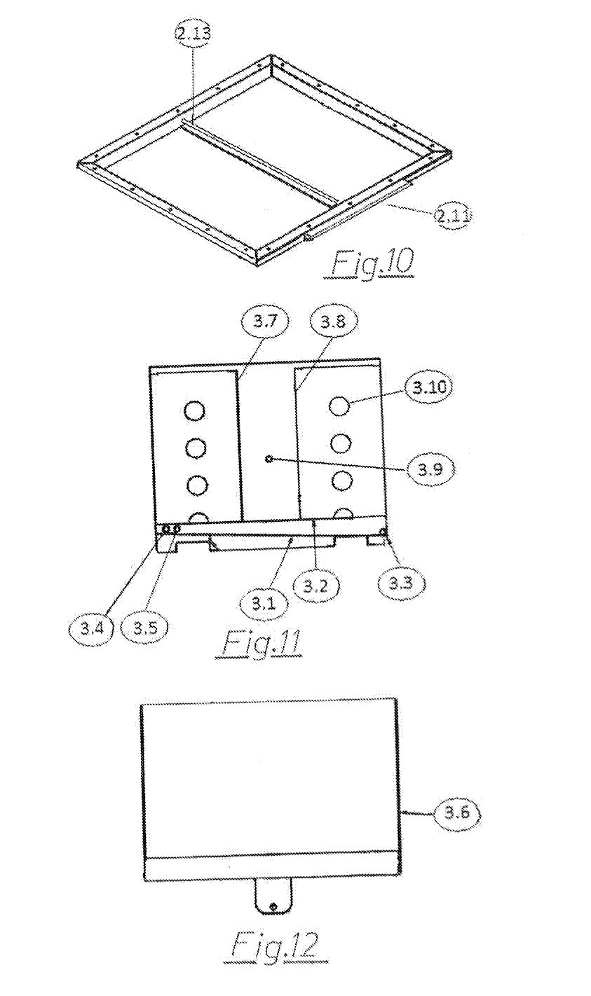

The oil (sealing fluid) flows to purification from both Line Wiper (IX) and Grease return (VIII) on the pressure control equipment in Wireline operations, and the oil from Line Wiper enters into the first separation unit (2.7, see FIG. 9) on the uppermost left hand side through a conduit (7, see FIG. 8; indicated as (1) in FIG. 2 of the first separation unit (II).

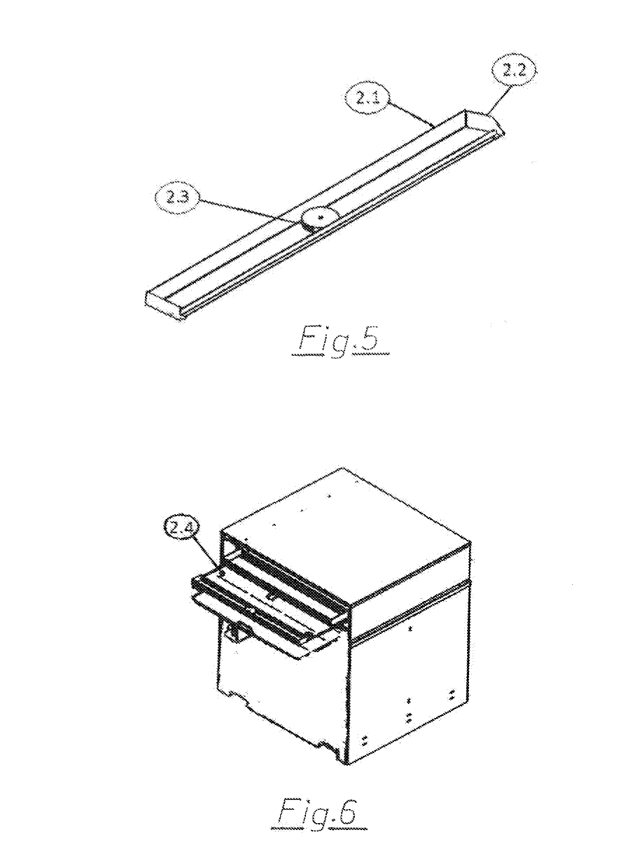

Uppermost in the separation unit (II) there is located a top drawer (X, see FIG. 4).

The sealing fluid is passed through the conduit (1, see FIG. 2) for thus arriving at the entrance of top drawer (X, see FIG. 4), and down through a splash cover (2) in the top drawer (X).

The top drawer is, in the depicted embodiment, shown to harbor three filtering baffles/walls (3,4,5, see FIG. 4) for separating gas bubbles by the aid of said three baffles that the oil first have to flow under, and then over. The three baffles have e.g. a 1 cm reduced height for each baffle, end the innermost one (3) is thus e.g. 3 cm high whereas the last one (5) is e.g. 1 cm high. This is because the volume of oil in the top drawer is to be as small as possible per square area during the purification/cleaning process.

The oil (sealing fluid) exits the top drawer via a conduit (6) located after the last baffle wall (5).

When the oil flows down from the top drawer (X) through the conduit (6) it is passed into the magnet drawer (2.1) depicted in FIG. 5.

In the magnet drawer (2.1) the sealing fluid first hits a magnet (2.3). The magnet collects all possible magnetic fragments from the well and cable carried away by the sealing fluid. The magnet (2,3) is in the depicted embodiment located at the center of the magnet drawer (2.1). The magnet drawer (2.1) has end walls (2.2) with cut grooves so it may be placed/hung onto the upper separating grille (2.4, see FIG. 6) in the top separating unit (II).

This construction is aimed at making the daily maintenance and service as easy as possible for the operator.

After the oil has flowed over the magnet 2,3 the magnet drawer is filled and the oil flows over the separating board (2.4, FIG. 6).

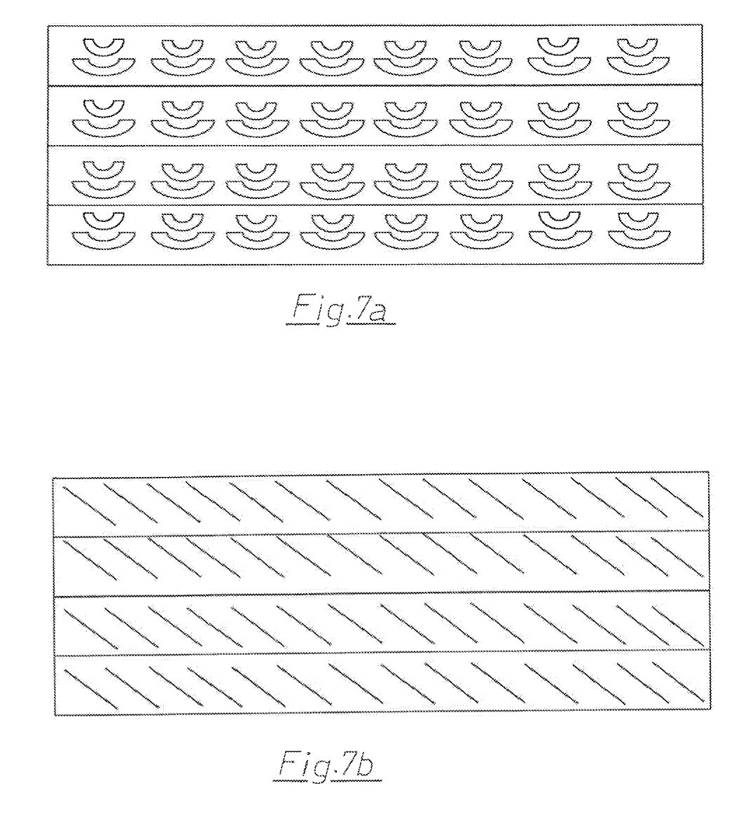

The separating board (2.4) has cut grooves and/or punched grooves with an underlying completely covering plate. The cut and/or punched grooves may comprise any geometrical form or geometrical pattern, but may e.g. comprise grooves of 4×6 millimeters (FIG. 7a),

An alternative geometrical pattern with skew grooves is depicted in FIG. 7b.

The device according to the present invention may in an alternative embodiment include separation grid(s) for the non-magnetic particles said grid(s) comprising) a number of upright brushes or fingers for retaining solid particles between the fingers/brushes/elements.

The cut and/or punched grooves have the effect of holding back fragments of drilling grit and other pollutants becoming stuck or hampered in their movement with the fluid flow in the grooves, and possible gas bubbles migrate out from the oil when it obtains a lesser viscosity when losing its particles by flowing downwards on the separating board, in the depicted embodiment at a width of 1 meter. The separating boards (1, 2 or more) move on tracks in the first separating chamber (II) being skewed e.g. at an angle of 5° in each direction relative to each other, leading the fluids to move ever downwards in the first separating chamber.

When the oil has flowed over the upper first separating board (5, see FIG. 2), the oil flows downwards onto one (or more) lower separating board(s) and is led to the front of the top box (II) where the oil is collected by a container wall (2.14, FIG. 8) leading the oil to the exits (2.15; 2.16).

The complete first separation tank (2.7, see FIG. 9) is watered in a horizontal position independent from the flotation tank (2.8, see FIG. 9) in the depicted embodiment by the aid of two adjustment screws in front (2.9; 2,10 in FIG. 9). The adjustment screws (2.9;2.10) are located on each side of the top box (2.7).

The adjustment screws (2.9;2.10 see FIG. 13) are secured in a bridge arrangement being fastened to the flotation tank (2.8, see FIG. 9). The adjustment screws (2.9; 2,10, see FIG. 13) are passing through two holes in the bridge (2.12, see FIG. 8) in the first separation unit (II).

The top box (II) has a rail at its bottom resting on a flat girder having a top at the center of the main tank (2.8 see FIG. 9) to be able to be adjusted in all directions to obtain a horizontal water position without there being any need to move the flotation tank (2.8).

In the depicted embodiment the oil flows out of the top box (II) and down into the main tank (2.8) through two conduits leading the oil between the floors (3.1; 3.2) in a double bottom in the flotation tank (2.8). Consequently the oil exits the top box (II) and enters the flotation tank (2.8) through two conduits (3.4, 3.5 see FIG. 11) leading the oil between the floors (3.1, 3.2 see FIG. 11) in the flotation tank (2.8).

The oil is passed over from the entrances (3.4, 3.5) to the opposite side of the flotation tank (2.8) wherein its bottom (3.2) in the depicted embodiment has a 15 cm aperture above the drainage port (3.3 see FIG. 11). The bottom (3.1 FIG. 11) is in the depicted embodiment tilted at an angle of 5 cm per meter towards the drainage port (3.3) from the entrances (3.4, 3.5), The oil emirates upwards in the tank (2.8) and is included into the total fluid volume. Well fluid including water and other fluids with larger density remain at the drainage port (3.3).

The floating device (14 FIG. 3) moves between vertical walls (3.7, 3.8 FIG. 11; 13 FIG. 3) functioning as a guide passage for the floating device (14) so that it will not become stuck.

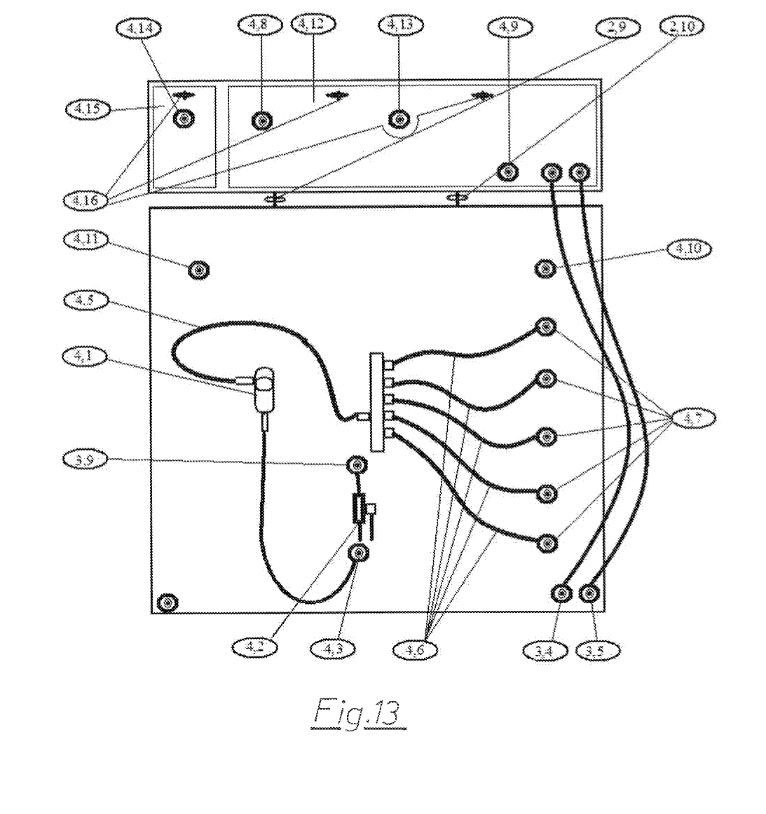

The oil having remained the longest time in the flotation tank (2.8) is pumped out when needed through the exit (3.9 FIG. 11; 15 FIG. 3) being secured to the floating device (3.6 FIG. 12; 14 FIG. 3) with e.g. a hose.

A pump (4.1 see FIG. 13) for pumping the fluid is in the depicted embodiment powered with pressurized air and is connected for filling up the flotation tank (2.8), for filling the sealing fluid pump unit and circulating the tank contents for mixing re-circulated oil with newly supplied oil.

The different actions are selected with a valve (4.2 see FIG. 13) being connected to the exit (3.9 FIGS. 11 and 13; 15 FIG. 3) and being opened or closed when pumping or not pumping.

In an alternative embodiment the device according to the invention may be constructed so that the floating device (14,3.6) includes a tube in its lower section, said tube penetrating into the mixture of sealing fluid/grease/oil/water which, after floatating the sealing fluid/grease to the top of the mixture in the second separation unit (III) being located beneath the separated layer of sealing fluid/grease for the removal of the mixture of oil and water.

It is alternatively possible to remove the floated sealing fluid/grease directly from the floatation chamber through e aid of the floating device, while removing the remaining mixture of oil and water through an exit at the bottom of the separation unit (III).

When the valve connected to the exit (3.9; 15) is closed for draining the tank (2.8), oil from a barrel being connected to a nipple (4.3) located at a hose prior to the pump (4.1). The hose (4.5) leading from the pump (4.1) and. being connected to the pump (4.5) leads oil to the main tank (III) through an optional array of circulation hoses (4.6) since there optionally is to be filled or circulated a volume of fluid from in the depicted embodiment one to five circulation ports (4.7 see FIG. 13). Fresh air is flushed into the first separation unit (2.7 see FIG. 9) through a fresh air entrance (4.8 see FIG. 13), and after air has been circulated through all the functions in the first separation unit (2.7) for removing all the collected gases, the air is exited from the air return exit (4.9 see FIG. 13). Then the air is passed down into the flotation tank (2.8) with a hose and into an air port (4.10 see FIG. 13). After having entered air into the flotation tank (2.8) through the port (4.10) gas will continuously be flushed out through the air return (4.11) being connected to a conduit being located in a safe area.

The main hatch of the separator (4.12 see FIG. 13) has in the depicted embodiment an entrance nipple (4.13 see FIG. 13) for sealing fluid return form the well control system mounted at the middle area so that the lid of the device according to the present invention may be closed during its operation for it to be possible to flush the system with fresh air while simultaneously the fluids hit the magnet (2.3) being located at the inside of the lid. The Line Wiper return nipple (4.14 see FIG. 13) is in the depicted embodiment located above a storage hatch (4.15 see FIG. 13) covering a space for storing all hoses and connections when the separator according to the invention is not in use. The lids may in the depicted embodiment be closed with the aid of turning handle locks (4.16 see FIG. 13) compressing a gasket between the lids and the compartment si that the system becomes tight.

The device according to the present invention functions through gravity, where the gravitational pull drives the fluids through the device, except in the flotation tank where the flotation effect separates the fluids with different densities from each other. Thus when referring to expressions as “downwards” or “upwards” in the disclosure, this relates to the gravity.

Although the device according to the present invention has been explained through reference to the embodiment depicted in the enclosed figures, the device may be altered while still maintaining its basic working concepts. Thus the device according to the invention includes the features specified in the enclosed set of claims.

The device according to the present invention has been explained through reference to oil risers and the oil industry. However, everywhere it is convenient or necessary to use sealing fluid/grease for ensuring or maintaining pressure integrity between two objects, the device according to the present invention may be used for re-circulating such fluids for saving the environment and the costs associated with supplying fresh sealing fluid/grease from a source of fresh fluid, as explained in the introduction of the present disclosure. Plants other than the oil industry reaping benefits from the present invention my be within the machine industry, the power plant industry, etc.

In one embodiment of the present invention, for making the separation proceed faster, it may be possible to equip the separation units (II, III) with heating devices, thereby lowering the viscosity of the sealing fluid/grease providing a better flow through the device during the separation process. Otherwise the separation process may proceed at ambient temperature.

Also in another embodiment the device according to the invention may include additional means for introducing substances such as an emulsifier, a coagulant, a flotation substance, a corrosion inhibitor, or other chemicals to the mixture. Such additions to the mixture may assist in improving the flow of the mixture and also assist in the separation of the components of the mixture as well as protecting the materials (walls, conduits, etc.) of the device against attack and/or corrosion from the components of the mixture.

Additionally the present invention includes a process for separating and re-winning used sealing fluid/grease/lubricating oil from a device comprising parts to perform under pressure, said parts being isolated between fluid-impenetrable walls, e.g. a riser, wherein the process comprises, after grease having been injected into the relevant parts of the relevant device for sealing the space between the instruments and the walls, pressurizing the space between the walls optionally be introducing more sealing fluid/grease into said space, or by introducing gas such as air into said space, for pushing a mixture of sealing fluid/grease/oil/water out from said space, said mixture being exited through an exit conduit located in said walls above said pressurized parts, wherein said device comprises a container/tank (I) including two or more separation units (II,III) for separating introduced sealing fluid/grease from oil and water in a mixture of said components, said separation units (II,III) standing in fluid communication with each other, and wherein
said first separation unit (II) comprises a number of separating drawers (4,5,6) optionally being slideable on tracks and that all have an inside, said inside comprising devices (4) for removing gas/air being contained in the sealing fluid/oil/water mixture, and a number of retention devices (5,6) for separating solid matter/solid particles from said mixture, as well as retention devices (8) for magnetid materials in said mixture, and
a second separation unit comprising a flotation tank (III) with internally perforated separation walls (13) and at least one flotation device (14) for separating sealing fluid/grease from water in said mixture, said separation being based on separating the components of the mixture through using differences in the densities of the components of the sealing fluid/oil/water mixture,
as well as an exit (15) for the separated sealing fluid/grease and another exit conduit (12) for the mixture of remaining oil and water, wherein the exit (15) for the separated sealing fluid/grease may be connected to a pump or similar device that may reintroduce the separated sealing fluid/grease into the space between the two relevant objects,

and either leading the separated sealing fluid/grease back to the space between the relevant parts and the walls or leading the separated sealing fluid/grease to a separate collection/storage tank.

Furthermore the above indicated process is suitable for a process wherein the fluid-impenetrable walls are a riser in an oil well.

Preferably or alternatively the process may be performed continuously or intermittently.

Specifically the invention includes the use of a device as disclosed supra or a process as disclosed supra for surveying the operation of a riser in an oil well or when closing the operation of a riser for the re-winning of used sealing fluid/grease/lubricating oil.

1. A device for collecting used sealing fluids/grease being used as sealing and lubricating medium between two objects characterized in that the device comprises a container/tank (I) including two or more separation units (II,III) for separating introduced sealing fluid/grease from oil and water in a mixture of said components, said separation units (II,III) standing in fluid communication with each other, and wherein
said first separation unit (II) comprises a number of separating drawers (4,5,6) and that all have an inside, said inside comprising devices (4) for removing gas/air from the sealing fluid/oil/water mixture, and a plurality of retention devices (5,6) for separating solid matter/solid particles from said mixture, as well as retention devices (8) for magnetic materials in said mixture, and
a second separation unit comprising a flotation tank (III) with internally perforated separation walls (13) and at least one flotation device (14) for separating sealing fluid/grease from water in said mixture, said separation being based on separating the components of the mixture through using differences in the densities of the components of the sealing fluid/oil/water mixture,
as well as an exit (15) for the separated sealing fluid/grease and another exit (12) for the mixture of remaining oil and water, wherein the exit (15) for the separated sealing fluid/grease is connected to a pump or similar device configured to reintroduce the separated sealing fluid/grease into the space between the two objects.

2. The device according to claim 1,
characterized in that the number of drawers (4,5,6) in the first separation unit (II) comprises a first separation drawer (4) having a plurality of, in relation to the flow direction of the sealing fluid/oil/water mixture cross baffle plates (IV) guiding the flow of the mixture alternately over and under the baffle plates (IV) for removing possible entrained gases in the mixture, and wherein the exit section (V) of the first separation drawer (4) for the partly purified mixture comprises devices (7) for guiding the mixture to a second separation drawer (5).

3. The device according to claim 1,
characterized in that the number of drawers in the first separation unit (II) comprises a second separation drawer receiving the partly purified mixture of sealing fluid/grease/oil/water from the first separation drawer, and wherein the second separation drawer comprises a magnet (2.3) in the flow channel (2.1) for the mixture for removing magnetic particles in the mixture.

4. The device according to claim 3,
characterized in that at least one drawer beneath the first and second drawers comprises at least one separating grid for non-magnetic solid particles.

5. The device according to claim 4,
characterized in that the at least one separating grid for non-magnetic particles comprises a number of recessed sections, such as sections with cut or punched grooves for capturing solid particles that may be retained/sunk into said sections.

6. The device according to claim 4,
characterized in that the at least one separating grid for the non-magnetic particles comprises a number of upright brushes or fingers for retaining solid particles between the fingers/brushes/elements.

7. The device according to claim 4,
characterized in that the at least one separating grid in the first separation unit (II) is/are skewed in the flow direction of the mixture for passing the mixture to the bottom of the first separation unit (II) by the aid of gravity.

8. The device according to claim 1,
characterized in that a last separation drawer comprises a drawer wall that, observed in the flow direction of the mixture, comprises a number of exits, said exits leading the sealing fluid/grease/oil/water mixture to the second separation unit (III).

9. The device according to claim 1,
characterized in that the second separation unit (III) comprises perforated walls (13, 3.7, 3.8), between said walls (13, 3.7,3.8) there being located and conducted a floating device (14,3.6) said floating device (14,3.6) being adjusted or float on top of the introduced mixture of sealing fluid/grease/oil/water, said second separation unit (III) being constructed as a separation chamber wherein sealing fluid/grease floats to the top of the mixture on account of its lesser density as compared to the other components of the mixture.

10. The device according to claim 9,
characterized in that the floating device (14,3.6) includes a tube in its lower section, said tube penetrating into the mixture of sealing fluid/grease/oil/water which, after floating the sealing fluid/grease to the top of the mixture in the second separation unit (III) being located beneath the separated layer of sealing fluid/grease for the removal of the underlying mixture of oil and water.

11. The device according to claim 8,
characterized in that the device comprises additional means for an emulsifier, a coagulant, a flotation substance, a corrosion inhibitor, or other chemicals to the mixture.

12. The device according to claim 1,
characterized in that the device comprises heating devices for heating the mixture to make the mixture less viscous.

13. A process for separating and re-winning used sealing fluid/grease/lubricating oil from a device comprising parts to perform under pressure, said parts being isolated between fluid-impenetrable walls, e.g. a riser,
characterized in that the process comprises, after grease having been injected into the relevant parts of the relevant device for sealing the space between the instruments and the walls, pressurizing the space between the walls optionally be introducing more sealing fluid/grease into said space, or by introducing gas such as air into said space, for pushing a mixture of sealing fluid/grease/oil/water out from said space, said mixture being exited through an exit conduit located in said walls above said pressurized parts, wherein said device comprises a container/tank (I) including two or more separation units (II,III) for separating introduced sealing fluid/grease from oil and water in a mixture of said components, said separation units (II,III) standing in fluid communication with each other, and wherein
said first separation unit (II) comprises a number of separating drawers (4,5,6) defining an inside, said inside comprising devices (4) for removing gas/air being contained in the sealing fluid/oil/water mixture, and a number of retention devices (5,6) for separating solid matter/solid particles from said mixture, as well as retention devices (8) for magnetic materials in said mixture, and
a second separation unit comprising a flotation tank (III) with internally perforated separation walls (13) and at least one flotation device (14) for separating sealing fluid/grease from water in said mixture, said separation being based on separating the components of the mixture through using differences in the densities of the components of the sealing fluid/oil/water mixture,
as well as an exit (15) for the separated sealing fluid/grease and another exit conduit (12) for the mixture of remaining oil and water, wherein the exit (15) for the separated sealing fluid/grease is connected to a pump or similar device to reintroduce the separated sealing fluid/grease into the space between the two relevant objects,
and either leading the separated sealing fluid/grease back to the space between the relevant parts and the walls or leading the separated sealing fluid/grease to a separate collection/storage tank.

14. The process according to claim 13, wherein the fluid-impenetrable walls is a riser in an oil well.

15. The process according to claim 13, wherein the process is performed continuously.

16. The use of a device according to claim 1 to survey the operation of a riser in an oil well or when closing the operation of a riser for the re-winning of used sealing fluid/grease/lubricating oil.

17. The process according to claim 13, wherein the separating drawers are slideably disposed on tracks.

18. The process according to claim 14, wherein the process is performed continuously.

19. The device according to claim 1, wherein the separating drawers are slideably disposed on tracks.

20. The device according to claim 1, wherein the objects comprise risers.
